(19) United States
(12) Patent Application Publication
(10) Pub. No.: US 2010/0129250 A1
(43) Pub. Date: May 27, 2010

(54) Auxiliary energy-accumulation and flow-enhancement device for hydraulic system of concrete pump

(76) Inventor: Yangdong He, Guangdong (CN)

Correspondence Address: JOHN CHEN, ROOM 303, 3F, NO. 25, SEC. 1, CHANGAN E. ROAD, TAIPEI, 10441, TW

(21) Appl. No.: 11/815,562

(22) PCT Filed: Jan. 23, 2006
(86) PCT No.: PCT/CN06/00111

§ 371 Date: Aug. 6, 2007

(30) Foreign Application Priority Data
Feb. 6, 2005 (CN) 200510031260.6

(51) Int. Cl. F15B 1/02

(52) U.S. Cl. 417/540

(57) ABSTRACT

An auxiliary energy-accumulation and flow-enhancement device for a hydraulic system of a concrete pump is provided. The device includes a connection oil passage 1 having an input end P and an output end B. A check valve 11 is disposed in the oil passage between the input end P and the output end B, and an energy accumulator 10 is connected to the oil passage between the check valve 11 and the input end P Pressure oil enters from the input end P, the energy accumulator accumulates energy, and power oil is output through the check valve 11. An oil passage pressure of the output end B controls an energy accumulation state of the energy accumulator 10. In the course of reversing the oil passage of a distribution valve of a working oil passage device, the auxiliary energy-accumulation and flow-enhancement device releases a corresponding amount of power oil for supplementation. When the oil passage of the distribution valve is not reversed, the auxiliary energy-accumulation and flow-enhancement device also provides the power oil to the working oil passage device. Therefore, the technical solution of the auxiliary energy-accumulation and flow-enhancement device is reliable, and the oil pump operates stably.

### BACKGROUND OF THE INVENTION

1. Field of Invention

The present invention relates to an auxiliary energy-accumulation and flow-enhancement device for a hydraulic system of a concrete pump.

2. Related Art

The hydraulic system of a concrete pump has a function of driving concrete pumping, distributing, and mixing devices of the concrete pump. Current hydraulic systems can be divided into two types, in which one is composed of a working oil passage device and a mixing oil passage device, i.e., dual-pump oil supply (as shown in FIG. 5), while the other is composed of a pumping oil passage device, a distributing oil passage device, and a mixing oil passage device, i.e., three-pump oil supply (as shown in FIG. 4), Both of the above types do not include an auxiliary energy-accumulation and flow-enhancement device. When a primary pump is working in a constant power control zone, the first type has the disadvantages of insufficient power of oil cylinders of a distribution valve caused by the increasing of the oil pump pressure and the reducing of displacement, and great hydraulic impact of the oil passages. As for the latter type, a constant pressure pump of the distribution valve shifts the working states between the maximum displacement and the minimum displacement frequently, so the working life is shortened, the failure rate rises, and the efficiency of the oil pump cannot be fully exerted. These defects have adverse effects on the working reliability of the concrete pump, and increase the manufacturing cost and maintenance cost.

### SUMMARY OF THE INVENTION

Directed to eliminating the defects of the prior art, the present invention provides an auxiliary energy-accumulation and flow-enhancement device for a hydraulic system of a concrete pump, which contributes to solving the problems of insufficient power of an oil cylinder of a distribution valve, improving a working state of the hydraulic system, and improving working performance, efficiency, and reliability of the hydraulic system of the concrete pump.

The present invention provides a technical solution of an auxiliary energy-accumulation and flow-enhancement device for a hydraulic system of a concrete pump. Referring to FIG. 1, the device includes a connection oil passage 1 having an input end P and an output end B. A check valve 11 is further disposed in the oil passage between the input end P and the output end B, and an energy accumulator 10 is connected to the oil passage between the check valve 11 and the input end P.

The working principle of the present invention is described as follows. Referring to FIGS. 2 and 3, an oil pump is used to provide pressure oil for the auxiliary energy-accumulation and flow-enhancement device. The oil pump can be a variable displacement pump or a constant displacement pump. The pressure oil enters from the input end P of the device, the energy accumulator 10 accumulates energy, and power oil is output from the output end B through the check valve 11. The energy accumulation capacity of the auxiliary energy-accumulation and energy-enhancement device changes with the variation of the pressure of hydraulic oil in the device. When the pressure increases, the energy accumulation and energy release capability is improved accordingly. The pressure variation is adapted to the oil passage pressure of the working oil passage device automatically. The oil pressure of the output end B controls an energy accumulation state of the energy accumulator 10. In the course of reversing the oil passage of the distribution valve of the working oil passage device, the auxiliary energy-accumulation and flow-enhancement device releases a corresponding amount of power oil for supplementation. When the oil passage of the distribution valve is not reversed, the auxiliary energy-accumulation and flow-enhancement device also provides the power oil to the working oil passage device.

The present invention has the following effects. The technical solution and features of the device improve the reliability and working performance of the working oil passage device effectively, so that the oil pump can operate in a stable working state to supply oil to the working oil passage.

### BRIEF DESCRIPTION OF THE DRAWINGS

FIG. 1 is a schematic structural view of an auxiliary energy-accumulation and flow-enhancement device for a hydraulic system of a concrete pump according to the present invention.

FIGS. 2-3 are reference diagrams of an, oil passage device composed of a working oil passage device, and an oil pump, and the present invention.

FIGS. 4-5 are reference diagrams of the principles of a hydraulic oil passage of a concrete pump of the prior art, respectively.

### DETAILED DESCRIPTION OF THE INVENTION

According to FIG. 1 and the structure described above, an embodiment of an auxiliary energy-accumulation and flow-enhancement device for a hydraulic system of a concrete pump of the present invention includes the connection oil passage 1 connected with hydraulic rubber pipes. One end of the connection oil passage 1 is an input end P, and the other end is an output end B. The check valve 11 is a commercially available model S10 check valve. The energy accumulator 10 is a commercially available model XL4 energy accumulator.

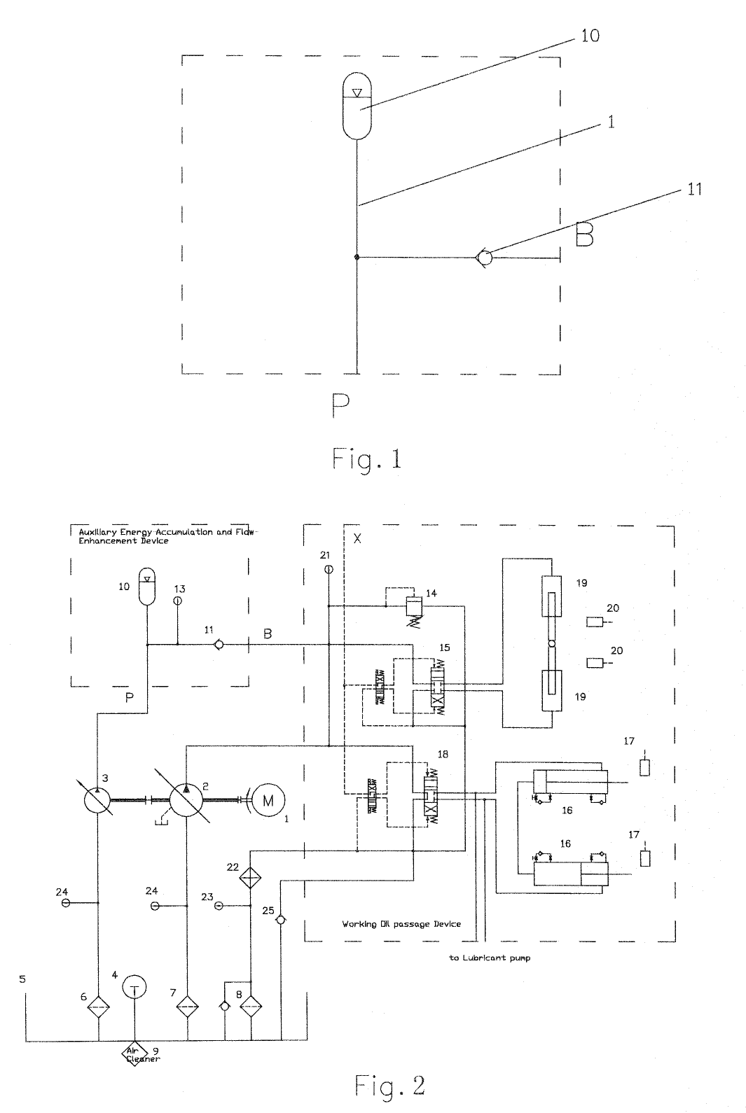

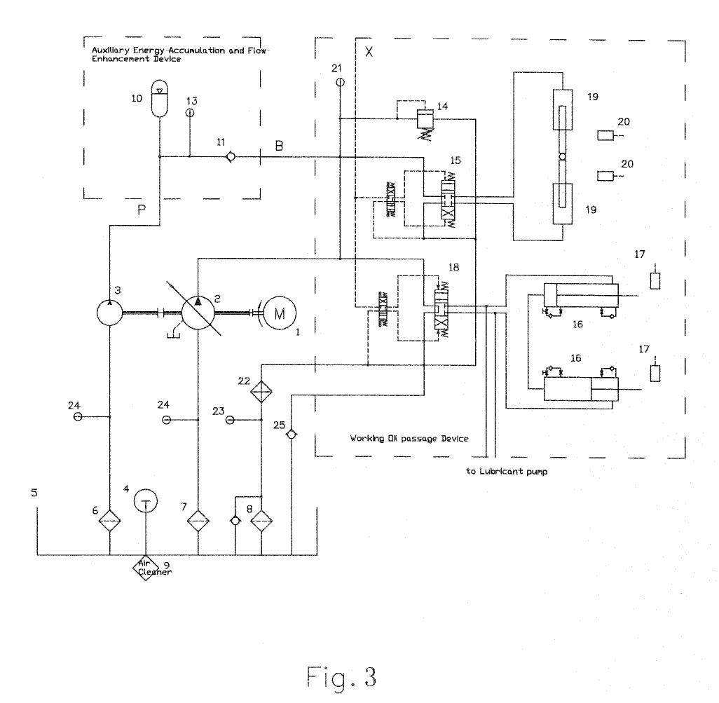

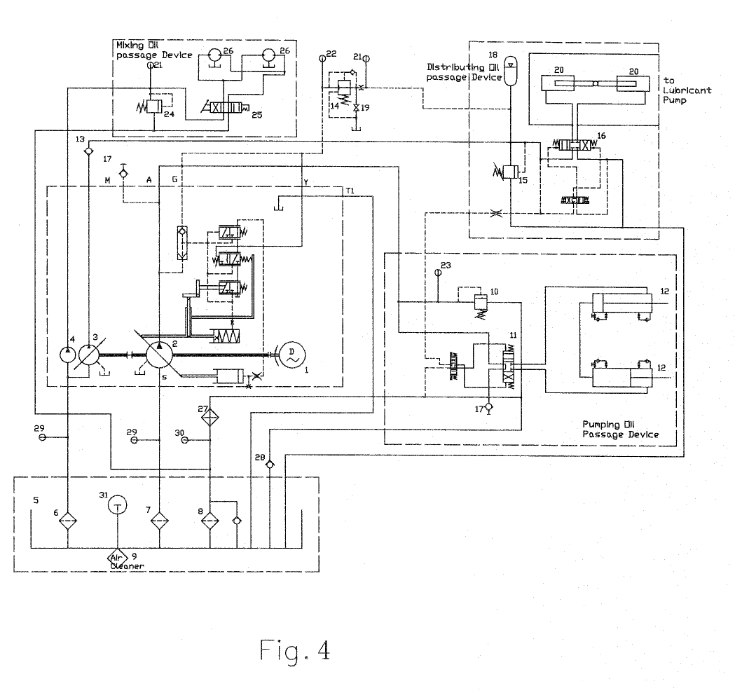

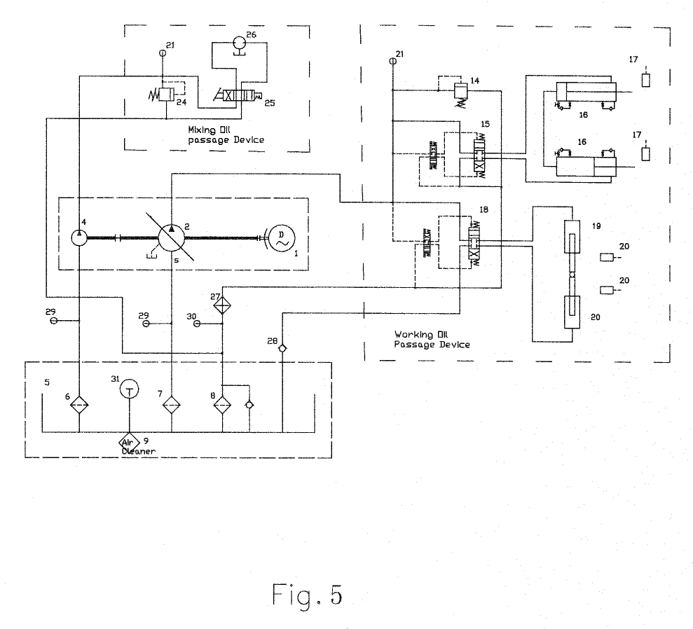

It can be known from FIGS. 2 and 3 that the variable displacement (constant displacement) pump 3 provides hydraulic oil to the auxiliary energy-accumulation and flow-enhancement device. The hydraulic oil enters from the input end P, and is output from the output end B. The pressure oil output from the output end B through the check valve (11) is in communication with a pressure oil zone of the working oil passage device. The oil passage pressure of the working oil passage device controls the oil passage pressure and energy accumulation state of the auxiliary energy-accumulation and flow-enhancement device. When the working oil passage device is in a pumping state (when a main oil cylinder 16 operates), the energy accumulator 10 of the auxiliary energy-accumulation and flow-enhancement device performs the constant pressure energy accumulation. After the energy accumulation is completed, the power oil is supplied to the working oil passage device. Thus, the pumping pressure increases, and the energy accumulation pressure and the capacity also rise. When the working oil passage device is in a reversing state (when an oil cylinder 19 of distribution valve operates), the energy accumulator 10 releases the energy, so as to coact with a primary pump 2 to ensure the pressure and flow rate required in reversing. In particular, when the primary oil pump 2 works in a constant power zone (the pumping pressure increases, and the displacement of the oil pump reduces), the auxiliary energy-accumulation and flow-enhancement device ensures the normal reversing of the working oil passage device. Meanwhile, the oil pump 3 remains working in a stable state.

What is claimed is:

1. An auxiliary energy-accumulation and flow-enhancement device for a hydraulic system of a concrete pump, comprising a connection oil passage (1) having an input end P and an output end B, wherein a check valve (11) is connected to an oil passage between the input end P and the output end B, and an energy accumulator (10) is connected to an oil passage between the check valve (11) and the input end P.
